(19) United States
(12) Patent Application Publication
(10) Pub. No.: US 2009/0271130 A1
(43) Pub. Date: Oct. 29, 2009

(54) METHOD FOR MEASURING SUSPENDED SEDIMENT CONCENTRATION IN WATER

(75) Inventor: Yin-Sung HSU, Taichung City (TW)

Correspondence Address: LADAS & PARRY, 5670 WILSHIRE BOULEVARD, SUITE 2100, LOS ANGELES, CA, 90036-5679, US

(73) Assignee: FENG CHIA UNIVERSITY, Taichung City (TW)

(21) Appl. No.: 12/426,433

(22) Filed: Apr. 20, 2009

(30) Foreign Application Priority Data
Apr. 28, 2008 (TW) 097115545

(51) Int. Cl. G01N 29/04; G01N 29/24

(52) U.S. Cl. 702/56

(57) ABSTRACT

A method for measuring suspended sediment concentration (SSC) in water includes the steps of: placing a vibrating-type SSC measuring probe in a target water body whose SSC is to be measured, and causing the SSC measuring probe to vibrate; measuring a vibratory signal resulting from the vibration of the SSC measuring probe, and obtaining a vibration response of the SSC measuring probe according to the vibratory signal; and obtaining the SSC of the target water body based upon the vibration response and a pre-established relationship between vibration responses of the SSC measuring probe to various known SSCs.

### BACKGROUND OF THE INVENTION

1. Field of the Invention

The present invention relates to a method for measuring suspended sediment concentration (SSC) in water, more particularly to a method for measuring suspended sediment concentration in water by referring to a vibration response of a vibrating-type SSC measuring probe placed in a target water body.

2. Description of the Related Art

Generally, a drying method (also known as weighing method) is used when measuring suspended sediment concentration (SSC) in a river, and includes the steps of sampling, drying and weighing. The sampling step is to sample a target river to obtain a river water sample, and the river water sample is then dried to obtain sediment in the river water sample. Finally, the weighing step is to weigh the sediment obtained from the drying step. The SSC (g/L) is equal to a quotient of the weight of the sediment (g) divided by the volume of the river water sample (L). However, procedures of the drying method are complicated, time-consuming and inconvenient.

Therefore, a method for measuring SSC using a vibrating tube has been proposed heretofore. A vibrating tube containing a water sample of a target water body with suspended sediment is used for measuring SSC in the target water body in this method. Although a measuring system for this method is quite complicated, the measuring operation is simply based on a principle that the square of the resonance frequency of a tube is proportional to the ratio between its stiffness and total mass, which includes the mass of the tube and that of the water sample. However, this method cannot be used for measuring a water body with heavy SSC. Moreover, since the water sample inside the vibrating tube must be forced to overcome the tube wall resistance, physical properties of the water sample inside the vibrating tube may be somewhat altered so as to no longer completely represent the properties of the target water body.

### SUMMARY OF THE INVENTION

Therefore, an object of the present invention is to provide an accurate, simple and convenient method for measuring suspended sediment concentration (SSC) in water.

Accordingly, a method for measuring SSC in water of this invention comprises the steps of:

a) placing a vibrating-type SSC measuring probe in a target water body whose SSC is to be measured, and causing the SSC measuring probe to vibrate;

b) measuring a vibratory signal resulting from the vibration of the SSC measuring probe, and obtaining a vibration response of the SSC measuring probe according to the vibratory signal; and

c) obtaining the SSC of the target water body based upon the vibration response obtained in step b) and a pre-established relationship between vibration responses of the SSC measuring probe to various known SSCs.

### BRIEF DESCRIPTION OF THE DRAWINGS

Other features and advantages of the present invention will become apparent in the following detailed description of the preferred embodiment with reference to the accompanying drawings, of which:

FIG. 1 is a flow chart of a preferred embodiment of a method for measuring suspended sediment concentration of the present invention;

FIG. 2 is a schematic diagram of a vibrating-type SSC measuring probe that is placed in a liquid sample having a known SSC, and that is used in the method of the preferred embodiment;

FIG. 3 is a table that indicates a relationship between vibration responses of the SSC measuring probe to various known SSCs, and that is obtained by measuring the vibration responses of the SSC measuring probe placed in various liquid samples having known SSCs;

FIG. 4 is a plot of a correlating function based upon the known SSCs of the liquid samples and the corresponding vibration responses of the SSC measuring probe; and

FIG. 5 is a schematic diagram similar to FIG. 2, but illustrating the SSC measuring probe placed in a target water body of a river.

### DETAILED DESCRIPTION OF THE PREFERRED EMBODIMENT

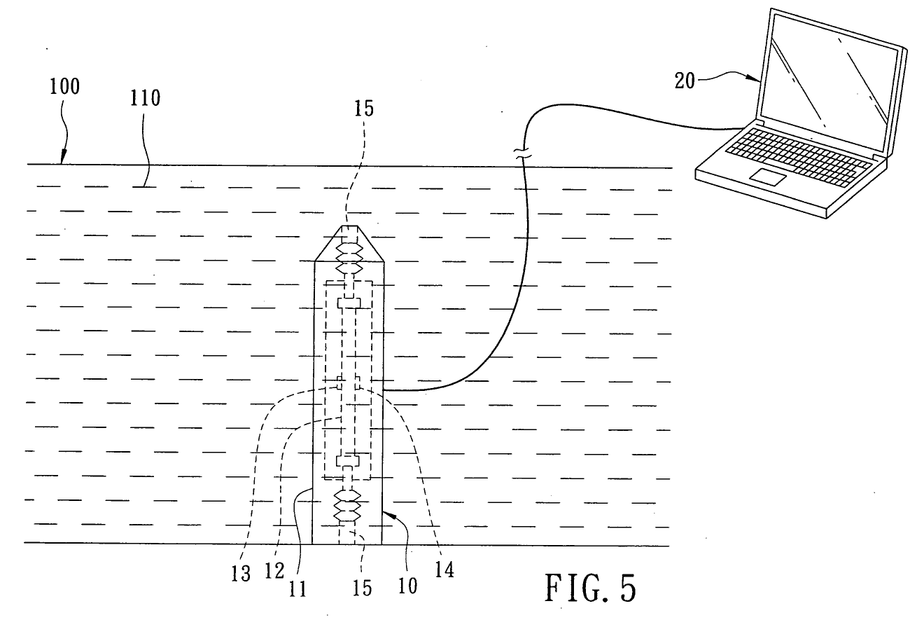

Referring to FIG. 5, a suspended sediment concentration (SSC) measuring system is used in the preferred embodiment of a method for measuring SSC of the present invention. The SSC measuring system is capable of measuring the SSC (g/L) of a target water body 110 of a river 100, and includes a vibrating-type SSC measuring probe 10 and a processing unit 20.

The SSC measuring probe 10 is adapted to be placed in the target water body 110 of the river 100. The SSC measuring probe 10 includes a casing body 11, a vibrating tube 12 supported in the casing body 11 by support members 15, and an exciting signal generator 13 and a transducer 14 both disposed at the vibrating tube 12. The exciting signal generator 13 is adapted for generating an exciting signal provided to the vibrating tube 12 so as to cause the vibrating tube 12 to vibrate. The transducer 14 is adapted for measuring a vibratory signal resulting from the vibration of the vibrating tube 12 of the SSC measuring probe 10. The processing unit 20 is coupled to the transducer 14 of the SSC measuring probe 10, and stores a correlating function therein. The correlating function will be described in greater detail in the succeeding paragraphs. In this embodiment, the processing unit 20 is a computer.

Before the method of the present invention is described in detail, the principle on which the method of this invention is based will be described herein.

When all parameters and characteristics of the vibrating tube 12 are known, a frequency of vibration of the vibrating tube 12 can be represented by

$$f = \frac{{α}_{n}}{2 π} \cdot \sqrt{\frac{E I}{{μ}_{0} {L}^{4}}} = \frac{α}{2 π} \cdot \sqrt{\frac{E I}{( {A}_{s} {ρ}_{s} + A ρ ) {L}^{4}}} , \qquad ( 1 )$$

wherein L is a total length of the vibrating tube 12, E is Young's modulus of the material of the vibrating tube 12, I is a cross-sectional moment of inertia, αₙ is a frequency coefficient of the support members 15, Aₛ is an area of a cross-section of the vibrating tube 12, ρₛ is a density of the material of the vibrating tube 12, A is an area of a cross-section of an inner space of the SSC measuring probe 10, and ρ is a density of the target water body 110.

After rearranging Equation 1, the density of the target water body 110 can be represented by

$$ρ = \frac{E I}{{( \frac{2 π}{{α}_{n}} )}^{2} {AL}^{4}} \cdot \frac{1}{{f}^{2}} - \frac{{A}_{s} {ρ}_{s}}{A} = {K}_{2} \cdot \frac{1}{{f}^{2}} - {K}_{0} , \\ wherein \\ {K}_{2} = \frac{E I}{{( \frac{2 π}{{α}_{n}} )}^{2} {AL}^{4}} , {K}_{0} = \frac{{A}_{s} {ρ}_{s}}{A} . \qquad ( 2 )$$

Since L, E, I, αₙ, Aₛ, ρₛ, A are known, K₂ and K₀ can be regarded as constants. It is noted that the density of the target water body 110 is a function of the frequency of the vibration of the vibrating tube 12. Generally, measurement of a period T is more convenient and accurate than measurement of the frequency f. Therefore, Equation 2 can be rewritten as

ρ=K₂T²−K₀. (3)

Equation 3 is a quadratic equation without a linear term. Considering common conditions, Equation 3 is modified as a standard quadratic equation,

ρₘ=k₀+k₁T+k₂T², (4)

wherein ρₘ is a density of the target water body 110, k₀ is a constant, k₁ is a coefficient of the linear term T, and k₂ is a coefficient of the quadratic term T².

In this embodiment, the vibrating tube 12 of the SSC measuring probe 10 is made of elinvar steel (3J58) that underwent heat treatment and that has a small thermal coefficient of temperature thereof is considerably small. Moreover, the coefficients k₀, k₁ and k₂ of the SSC measuring probe used in this embodiment are −2.8348565989, 0.00387781, and 0.0000021625, respectively. Compared with k₀ and k₁, k₂ is considerably small, and can be omitted, i.e., regarded as 0. Therefore, Equation 4 can be modified as

ρₘ=k₀+k₁T. (5)

From Equation 5, it is noted that the density of the target water body 110 is a linear function of the period of the frequency of the vibration of the vibrating tube 12 placed in the target water body 110.

Furthermore, since weight of the target water body 110 is equal to a total amount of weight of pure water and weight of suspended sediment in the pure water, the following equation can be obtained,

Vₘρₘ=Vₛρₛ+(Vₘ−Vₛ)ρ_{w}, (6)

wherein Vₘ (cm³) is a volume of the target water body 110, ρₘ (g/cm³) is the density of the target water body 110, Vₛ (cm³) is a volume of the suspended sediment in the target water body 110, ρₛ (g/cm³) is a density of the suspended sediment, and ρ_{w} (g/cm³) is a density of the pure water.

Additionally, the SSC (g/L) of the target water body 110 is defined as a quotient of the weight of the suspended sediment divided by the volume of the target water body 110, and can be represented by

$${C}_{s} = \frac{{V}_{s} {ρ}_{s}}{{V}_{m}} . \qquad ( 7 )$$

From Equations 6 and 7, the SSC of the target water body 110 can be represented by

$${C}_{s} = ( {ρ}_{m} - {ρ}_{w} ) \frac{{ρ}_{s}}{{ρ}_{s} - {ρ}_{w}} . \qquad ( 8 )$$

Since the unit of Cₛ is defined as (g/L) and the unit of the densities ρₘ, ρₛ and ρ_{w} is (g/cm³), Equation 8 is multiplied by 1000 for a uniform unit,

$${C}_{s} = ( {ρ}_{m} - {ρ}_{w} ) \frac{{ρ}_{s}}{{ρ}_{s} - {ρ}_{w}} \times 1000. \qquad ( 9 )$$

Since ρₛ and ρ_{w} are constants, Cₛ is a linear function of ρₘ. From Equations 5 and 9, the SSC of the target water body 110 is also a linear function of the period of the frequency of the vibration of the vibrating tube 12 placed in the target water body 110. In other words, when the period of the frequency of the vibration of the vibrating tube 12 is measured, the SSC of the target water body 110 can be obtained, and that is the principle of the method of the present invention.

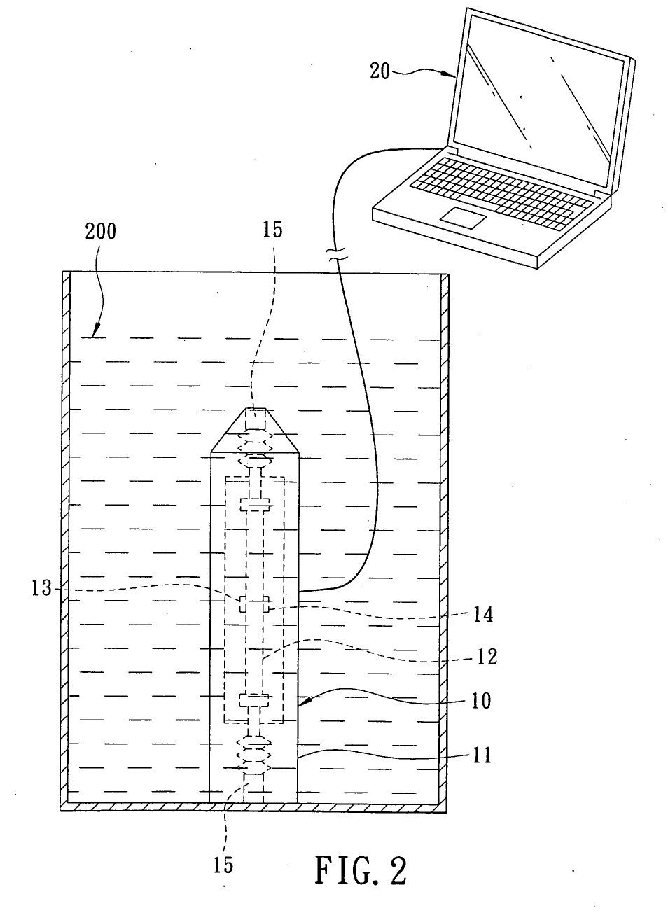

Before measuring the SSC of the target water body 110, it is required to pre-establish the correlating function that represents a relationship between the periods and the SSCs. Referring to FIG. 2, for each of a plurality of liquid samples 200 having known SSCs, the SSC measuring probe 10 is caused to vibrate by providing the exciting signal generated by the exciting signal generator 13 to the vibrating tube 12 while the SSC measuring probe 10 is placed in one of the liquid samples 200. The transducer 14 is the operated to measure a vibratory signal resulting from the vibration of the vibrating tube 12 of the SSC measuring probe 10, and the processing unit 20 obtains the period of the vibration of the vibrating tube 12 according to the vibratory signal from the transducer 14. After measuring the corresponding period of the vibration of the vibrating tube 12 for each of the liquid samples 200, the processing unit 20 is subsequently operated to establish the correlating function based upon the known SSCs of the liquid samples 200 and the corresponding periods, and stores the correlating function therein.

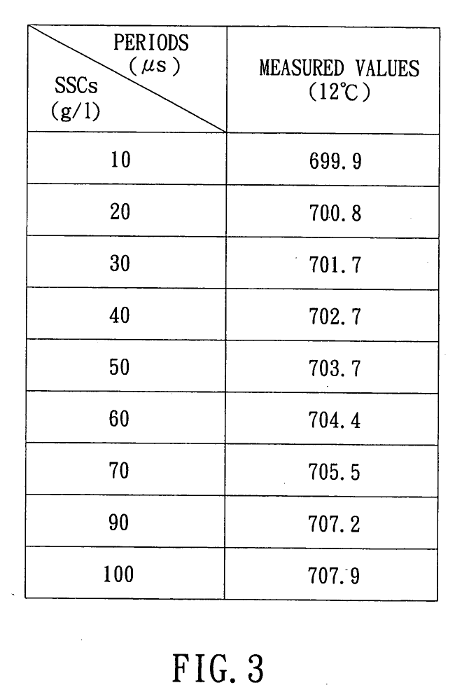

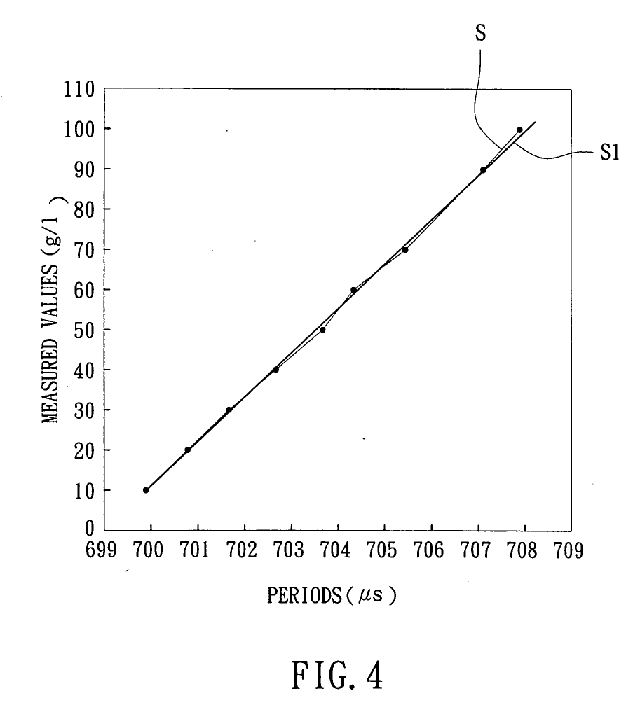

In this embodiment, the SSCs of the liquid samples 200 are 10 (g/L), 20 (g/L), 30 (g/L), 40 (g/L), 50 (g/L), 60 (g/L), 70 (g/L), 90 (g/L), and 100 (g/L), respectively, and temperature of the liquid samples 200 is kept uniform at 12° C. For each of the liquid samples, the SSC measuring probe 10 obtains a corresponding period of frequency of vibration of the vibrating tube 12, and a table indicating the known SSCs and the corresponding periods can be established as shown in FIG. 3. Referring to FIG. 4, a real curve (S) can be obtained based upon the known SSCs and the periods in the table of FIG. 3, and then a linear regression function (a curve thereof shown as (S1) in FIG. 4) can be obtained as y=11.117x−7770.7, i.e., the correlating function. The correlating function is stored in the processing unit 20 for calculating the SSC of the target water body 110.

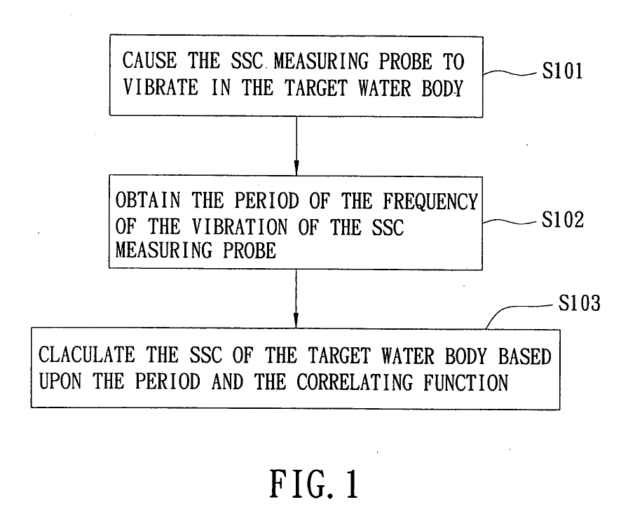

Referring to FIGS. 1 and 5, the preferred embodiment of the method for measuring suspended sediment concentration in water of the present invention is implemented using the SSC measuring system shown in FIG. 5, and includes the following steps.

Step (S101) is to place the SSC measuring probe 10 in the target water body 110 whose SSC is to be measured, and to cause the SSC measuring probe 10 to vibrate by providing the exciting signal to the vibrating tube 12.

In step (S102), the vibratory signal resulting from the vibration of the vibrating tube 12 of the SSC measuring probe 10 is measured using the transducer 14 and is transmitted to the processing unit 20. The processing unit 20 is then operated to obtain the period of the frequency of the vibration of the vibrating tube 12 according to the vibratory signal from the transducer 14.

In step (S103), the processing unit is further operated to calculate the SSC of the target water body 110 based upon the period obtained in step (S102) and the correlating function (y=11.117x−7770.7) stored therein.

In sum, after placing the SSC measuring probe 10 in the target water body 110, the SSC measuring system is operated to obtain the period of the vibration of the vibrating tube 12, to thereby obtain the SSC of the target water body 110 according to the correlating function. Since procedures of the method of the present invention are convenient, simple and time-saving, and the measured SSC is accurate, efficiency of measurement can be enhanced.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method for measuring suspended sediment concentration (SSC) in water, said method comprising:
a) placing a vibrating-type SSC measuring probe in a target water body whose SSC is to be measured, and causing the SSC measuring probe to vibrate;
b) measuring a vibratory signal resulting from the vibration of the SSC measuring probe, and obtaining a vibration response of the SSC measuring probe according to the vibratory signal; and
c) obtaining the SSC of the target water body based upon the vibration response obtained in step b) and a pre-established relationship between vibration responses of the SSC measuring probe to various known SSCs.

2. The method as claimed in claim 1, wherein the pre-established relationship in step c) is established by:
for each of a plurality of liquid samples having known SSCs, causing the SSC measuring probe to vibrate while the SSC measuring probe is placed in the liquid sample;
for each of the liquid samples, measuring a vibratory signal resulting from the vibration of the SSC measuring probe, and obtaining a vibration response of the SSC measuring probe according to the vibratory signal; and
establishing a correlating function based upon the known SSCs of the liquid samples and the corresponding vibration responses of the SSC measuring probe obtained for the liquid samples.

3. The method as claimed in claim 2, wherein:
a transducer is used to measure the vibratory signal; and
a processing unit is coupled to the transducer, obtains the vibration response of the SSC measuring probe according to the vibratory signal, stores the correlating function therein, and obtains the SSC of the target water body based upon the vibration response and the correlating function.

4. The method as claimed in claim 2, wherein the correlating function is a linear regression function.

5. The method as claimed in claim 1, wherein the vibration response obtained in step b) is a period of a frequency of the vibration of the SSC measuring probe.
